(19) United States
(12) Patent Application Publication
(10) Pub. No.: US 2024/0274369 A1
(43) Pub. Date: Aug. 15, 2024

(54) SOLID ELECTROLYTIC CAPACITOR

(71) Applicant: Panasonic Intellectual Property Management Co., Ltd., Kadoma-shi, Osaka (JP)

(72) Inventor: Masahiko Taira, KYOTO FU (JP)

(73) Assignee: Panasonic Intellectual Property Management Co., Ltd., Kadoma-shi, Osaka (JP)

(21) Appl. No.: 18/566,751

(22) PCT Filed: May 24, 2022
(86) PCT No.: PCT/JP2022/021169

§ 371 Date: Dec. 4, 2023

(30) Foreign Application Priority Data
Jun. 22, 2021 (JP) 2021-103453

(51) Int. Cl. H01G 9/012; H01G 9/15; H01G 9/26

(52) U.S. Cl. CPC H01G 9/012; H01G 9/26; H01G 9/15

(57) ABSTRACT

A solid electrolytic capacitor includes at least one capacitor element having an anode section and a cathode section an anode lead terminal electrically connected to the anode section, and a cathode lead terminal electrically connected to the cathode section. Each of the anode and cathode lead terminals and has a first principal surface, a second principal surface, and a cut surface formed by cutting from the first principal surface toward the second principal surface. In the cut surface of at least the cathode lead terminal of the anode and cathode lead terminals, a first distance from the first principal surface to a boundary between a shear surface and a fracture surface is 80% or less of a second distance from the first principal surface to the second principal surface.

### TECHNICAL FIELD

The present disclosure relates to a solid electrolytic capacitor.

### BACKGROUND ART

Conventionally, a solid electrolytic capacitor including at least one capacitor element, an anode lead terminal, and a cathode lead terminal has been known (e.g., Patent Literature 1). In the solid electrolytic capacitor of Patent Literature 1, at least one capacitor element is stacked on both sides of each of an anode lead terminal and a cathode lead terminal. The anode lead terminal is electrically connected to an anode section included in the capacitor element, while the cathode lead terminal is electrically connected to a cathode section included in the capacitor element.

### CITATION LIST

### Patent Literature

Patent Literature 1: Japanese Laid-Open Patent Publication No. 2010-028139

### SUMMARY OF INVENTION

A solid electrolytic capacitor according to one aspect of the present disclosure includes: at least one capacitor element having an anode section and a cathode section; an anode lead terminal electrically connected to the anode section; and a cathode lead terminal electrically connected to the cathode section; wherein each of the anode lead terminal and the cathode lead terminal has a first principal surface, a second principal surface, and a cut surface formed by cutting from the first principal surface toward the second principal surface, and in the cut surface of at least the cathode lead terminal of the anode lead terminal and the cathode lead terminal, a first distance from the first principal surface to a boundary between a shear surface and a fracture surface is 80% or less of a second distance from the first principal surface to the second principal surface.

According to the present disclosure, it is possible to suppress the occurrence of a short circuit phenomenon.

### BRIEF DESCRIPTION OF DRAWINGS

FIG. 1 is a schematic cross-sectional view of a solid electrolytic capacitor according to Embodiment 1.

FIG. 2 is a schematic perspective view of a capacitor element.

FIG. 3 is a schematic perspective view of lead terminals.

FIG. 4 is a perspective view of a plurality of capacitor elements stacked on lead terminals.

FIG. 5 is a schematic cross-sectional view of a peripheral area of a cut surface of each lead terminal.

FIG. 6 is a schematic cross-sectional view of a solid electrolytic capacitor according to Embodiment 2.

### DESCRIPTION OF EMBODIMENTS

Prior to the description of embodiments, a problem in the prior art will be briefly described below.

In general, the anode lead terminal and the cathode lead terminal are each produced by cutting a metal sheet by press working or the like. Therefore, a burr formed during cutting is present on each of the anode lead terminal and the cathode lead terminal at the edge of the cut surface. If such a burr sticks in the capacitor element, a phenomenon may occur in which the anode section and the cathode section become electrically connected with each other via the burr (hereinafter, a short circuit phenomenon). Under such circumstances, one of the objectives of the present disclosure is to suppress the occurrence of a short circuit phenomenon.

In view of the above problem, the present disclosure can realize a solid electrolytic capacitor in which the occurrence of a short circuit phenomenon is suppressed.

In the following, embodiments of a solid electrolytic capacitor according to the present disclosure will be described below by way of examples. It is to be noted, however, that the present disclosure is not limited to the examples described below. In the description below, specific numerical values and materials are exemplified in some cases, but other numerical values and materials may be applied as long as the effects of the present disclosure can be achieved.

### (Solid Electrolytic Capacitor)

A solid electrolytic capacitor according to the present disclosure includes at least one capacitor element, an anode lead terminal, and a cathode lead terminal.

The capacitor element has an anode section and a cathode section. Between the anode section and the cathode section, an insulation section that provides electrical insulation therebetween may be disposed. The insulation section may be constituted of, for example, an insulating tape or an insulating resin.

The anode section may be configured to include a part (a part on one side with respect to the insulation section) of an anode body made of a valve metal included in the capacitor element. The cathode section may be constituted of a solid electrolyte layer and a cathode layer that are sequentially formed on the surface of a cathode forming part (a part on the other side with respect to the insulation section) which is the remainder of the anode body. A dielectric layer is disposed between the anode body and the solid electrolyte layer.

Examples of the valve metal constituting the anode body include aluminum, tantalum, niobium, and titanium. The anode body may be a foil of a valve metal or a porous sintered body made of a valve metal.

The dielectric layer is formed on at least the surface of the cathode forming part which is the remainder of the anode body. The dielectric layer may be constituted of an oxide (e.g., aluminum oxide) formed on the surface of the anode body by anodization, a gas phase method, such as vapor deposition, or the like.

The solid electrolyte layer is formed on the surface of the dielectric layer. The solid electrolyte layer may contain a conductive polymer. The solid electrolyte layer may further contain a dopant, as necessary.

As the conductive polymer, known materials used in solid electrolytic capacitors, such as r-conjugated conductive polymers, can be used. Examples of the conductive polymer include polymers whose backbones are polypyrrole, polythiophene, polyaniline, polyfuran, polyacetylene, polyphenylene, polyphenylene vinylene, polyacene, and polythiophene vinylene. Preferred among them are a polymer whose backbone is polypyrrole, polythiophene, or polyaniline. The aforementioned polymers also include a homopolymer, a copolymer of two or more kinds of monomers, and derivatives of them (including a substituted product having a substituent). For example, polythiophene includes poly(3,4-ethylenedioxythiophene) and the like. The conductive polymer may be used singly or in combination of two or more kinds.

As the dopant, for example, at least one selected from the group consisting of a low molecular weight anion and a polyanion is used. The anion includes, for example, a sulfate ion, a nitrate ion, a phosphate ion, a borate ion, organic sulfonate ions, a carboxylate ion, and the like, but are not limited thereto. As the dopant that generates a sulfonate ion, benzenesulfonic acid, p-toluenesulfonic acid, naphthalenesulfonic acid, and the like are exemplified. The polyanion includes, for example, polymer-type polysulfonic acids, polymer-type polycarboxylic acids, and the like. Examples of the polymer-type polysulfonic acids include polyvinylsulfonic acid, polystyrenesulfonic acid, polyallylsulfonic acid, polyacrylsulfonic acid, and polymethacrylsulfonic acid. Examples of the polymer-type polycarboxylic acids include polyacrylic acid and polymethacrylic acid. The polyanion also includes polyestersulfonic acid, phenol sulfonic acid novolac resin, and the like. The polyanion, however, is not limited thereto.

The solid electrolyte layer may further contain, as necessary, a known additive and a known conductive material other than the conductive polymer. Examples of such a conductive material includes at least one selected from the group consisting of a conductive inorganic material, such as manganese dioxide, and a TCNQ complex salt.

The cathode layer may be constituted of a carbon layer formed on the surface of the solid electrolyte layer, and a conductor layer formed on the surface of the carbon layer. The conductor layer may be constituted of a silver paste. As the silver paste, for example, a composition containing silver particles and a resin component (binder resin) can be used. As the resin component, a thermoplastic resin can be used, but a thermosetting resin such as an imide-series resin and an epoxy resin, is preferably used.

The anode lead terminal is electrically connected to the anode section of the capacitor element. The anode lead terminal has a first principal surface, a second principal surface opposite to the first principal surface, and a cut surface formed by cutting from the first principal surface toward the second principal surface. The cut surface includes, from the first principal surface toward the second principal surface, a sag, a shear surface, and a fracture surface. The sag refers to a smooth surface formed as a result of the first principal surface having been drawn and stretched.

The cathode lead terminal is electrically connected to the cathode section of the capacitor element. The cathode lead terminal has a first principal surface, a second principal surface opposite to the first principal surface, and a cut surface formed by cutting from the first principal surface toward the second principal surface. The cut surface includes, from the first principal surface toward the second principal surface, a sag, a shear surface, and a fracture surface.

In the cut surface of at least the cathode lead terminal of the anode lead terminal and the cathode lead terminal, a first distance from the first principal surface to a boundary between the shear surface and the fracture surface is 80% or less of a second distance from the first principal surface to the second principal surface. When the first distance falls within such a range, only a very small burr is formed at the edge of the cut surface on the second principal surface side in the production of each lead terminal. Even if such a tiny burr contacts the capacitor element, the burr will not penetrate through from the cathode layer to the dielectric layer, and no short circuit phenomenon will occur. Therefore, the occurrence of a short circuit phenomenon can be suppressed.

In the cut surface of at least the cathode lead terminal of the anode lead terminal and the cathode lead terminal, the first distance may be 70% or less of the second distance. According to this configuration, the burr formed at the edge of the cut surface on the second principal surface side becomes further small. Therefore, the occurrence of a short circuit phenomenon can be further suppressed.

Each of the anode lead terminal and the cathode lead terminal may be constituted of a copper alloy containing copper and an element other than copper (e.g., at least one selected from the group consisting of tin, nickel, chromium, phosphorus, zinc, silicon, and iron). Among elements other than copper, at least one selected from the group consisting of tin, nickel, and phosphorus is desirable, and more desirably, three kinds of elements, tin, nickel, and phosphorus, are contained. The content of the element(s) other than copper in the copper alloy may be, for example, 1 mass % or more and 3 mass % or less. The content of tin may be 0.9 mass % or more and 2.5 mass % or less. The content of nickel may be 0.1 mass % or more and 1.2 mass % or less. The content of phosphorus may be 0.01 mass % or more and 0.2 mass % or less. Each of the lead terminals made of such a copper alloy hardly stretches as it is cut, thus forming no large burr at the edge of the cut surface. Therefore, the occurrence of a short circuit phenomenon can be further suppressed.

The capacitor element may be electrically connected to the cathode lead terminal only on one of the first principal surface and the second principal surface.

The capacitor element may be electrically connected to the anode lead terminal only on one of the first principal surface and the second principal surface.

The solid electrolytic capacitor may include a plurality of the capacitor elements. Part of the plurality of the capacitor elements may be electrically connected to the cathode lead terminal on one of the first principal surface and the second principal surface, and the rest of the plurality of the capacitor elements may be electrically connected to the cathode lead terminal on the other one of the first principal surface and the second principal surface.

The solid electrolytic capacitor may include a plurality of the capacitor elements. Part of the plurality of the capacitor elements may be electrically connected to the anode lead terminal on one of the first principal surface and the second principal surface, and the rest of the plurality of the capacitor elements may be electrically connected to the anode lead terminal on the other one of the first principal surface and the second principal surface.

The anode lead terminal has a through-hole in a connection surface on which the at least one capacitor element is connected. According to this configuration, when connecting the anode section of the capacitor element and the anode lead terminal to each other by resistance welding, favorable welding can be performed, and the equivalent series resistance (ESR) of the solid electrolytic capacitor can be reduced.

The cathode lead terminal may have a guide portion that guides the at least one capacitor element. With such a guide portion, the capacitor elements can be easily positioned. The guide portion may be formed by, for example, providing a protrusion at the end of the cathode lead terminal and bending the protrusion along the side surface of the cathode section.

As described above, according to the present disclosure, it is possible to suppress the occurrence of a short circuit phenomenon in the solid electrolytic capacitor.

In the following, an example of the solid electrolytic capacitor according to the present disclosure will be specifically described with reference to the drawings. The components as described above can be applied to the components of the below-described example of the solid electrolytic capacitor. The components of the below-described example of the solid electrolytic capacitor can be modified based on the description above. The matters as described below may be applied to the above embodiments. Of the components of the below-described example of the solid electrolytic capacitor, the components which are not essential to the solid electrolytic capacitor according to the present disclosure may be omitted. The figures below are schematic and not intended to accurately reflect the shape and the number of the actual members.

### Embodiment 1

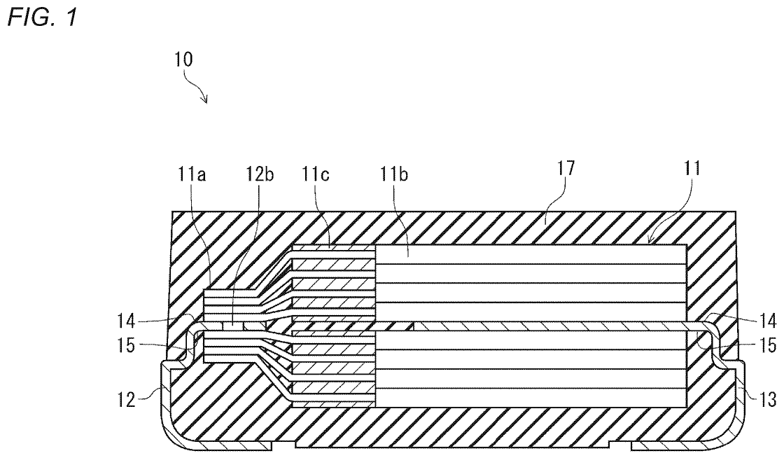

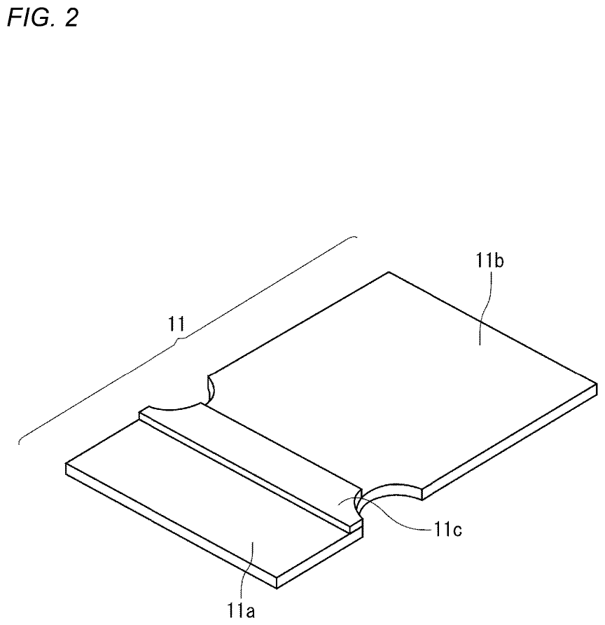

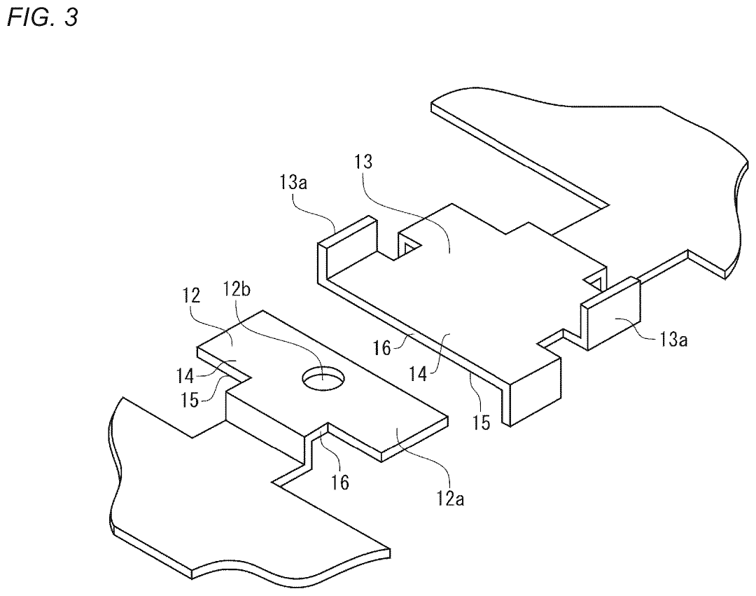

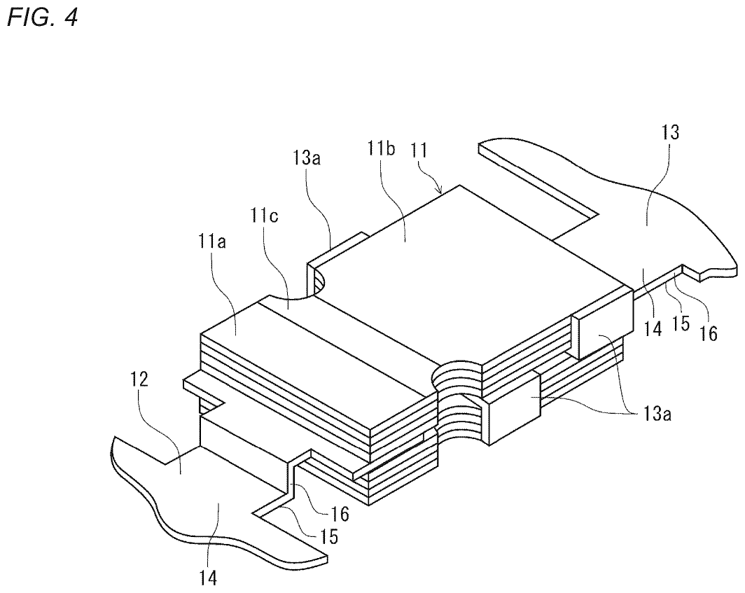

Embodiment 1 of the present disclosure will be described. A solid electrolytic capacitor 10 of the present embodiment has a double-sided structure (a structure in which capacitor elements are stacked on both sides of each lead terminal). As illustrated in FIGS. 1 to 5, the solid electrolytic capacitor 10 includes a plurality of capacitor elements 11, an anode lead terminal 12, a cathode lead terminal 13, and a packaging resin 17.

The plurality of the capacitor elements 11 each have an anode section 11a, a cathode section 11b, and an insulation section 11c. The anode section 11a is constituted of a part of an anode body made of a valve metal (e.g., aluminum). The cathode section 11b is constituted of a solid electrolyte layer and a cathode layer that are sequentially formed on the surface of a cathode forming part that is a remainder of the anode body. The insulation section 11c is made of an insulating tape, providing electrical insulation between the anode section 11a and the cathode section 11b. A dielectric layer is disposed between the anode body and the solid electrolyte layer.

Part of the plurality of the capacitor elements 11 (in this example, the upper four capacitor elements 11 in FIG. 1) are electrically connected to the anode lead terminal 12 and the cathode lead terminal 13 on a later-described first principal surface 14. The rest of the plurality of the capacitor elements 11 (in this example, the lower four capacitor elements 11 in FIG. 1) are electrically connected to the anode lead terminal 12 and the cathode lead terminal 13 on a later-described second principal surface 15.

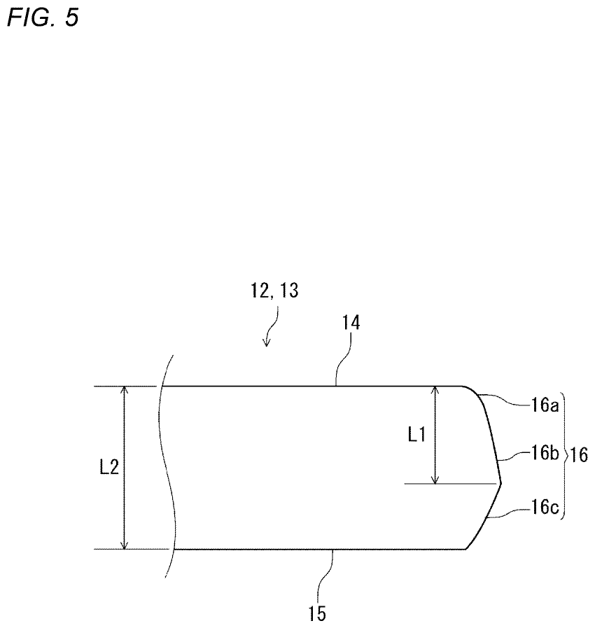

The anode lead terminal 12 is electrically connected to the anode sections 11a of the capacitor elements 11. The anode lead terminal 12 has the first principal surface 14 (the principal surface facing upward in each figure), the second principal surface 15 opposite to the first principal surface 14, and a cut surface 16 formed by cutting from the first principal surface 14 toward the second principal surface 15. The cut surface 16 includes, from the first principal surface 14 toward the second principal surface 15, a sag 16a, a shear surface 16b, and a fracture surface 16c (see FIG. 5).

The anode lead terminal 12 is made of a copper alloy containing copper and at least one selected from the group consisting of tin, nickel, chromium, phosphorus, zinc, silicon, and iron. However, the anode lead terminal 12 may be made of another metal.

The anode lead terminal 12 has a through-hole 12b in a connection surface 12a on which the plurality of the capacitor elements 11 are connected. The through-hole 12b is a circular hole that penetrates the anode lead terminal 12 in the thickness direction. The through-hole 12b is arranged at a position overlapping the anode section 11a of the capacitor element 11 when viewed in the thickness direction of the anode lead terminal 12 (the vertical direction in FIG. 1). The shape of the through-hole 12b is not limited to a circular shape, and may be any other shape.

The cathode lead terminal 13 is electrically connected to the cathode sections 11b of the capacitor elements 11. The cathode lead terminal 13 has a first principal surface 14 (a principal surface facing upward in each figure), a second principal surface 15 opposite to the first principal surface 14, and a cut surface 16 formed by cutting from the first principal surface 14 toward the second principal surface 15. The cut surface 16 includes, from the first principal surface 14 toward the second principal surface 15, a sag 16a, a shear surface 16b, and a fracture surface 16c (see FIG. 5).

The cathode lead terminal 13 is made of a copper alloy containing copper and at least one selected from the group consisting of tin, nickel, chromium, phosphorus, zinc, silicon, and iron. However, the cathode lead terminal 13 may be made of another metal. The constituent material of the cathode lead terminal 13 may be the same as or different from the constituent material of the anode lead terminal 12.

The cathode lead terminal 13 has a connecting portion 13a that is connected to the side surfaces of the plurality of the capacitor elements 11 via a conductive paste (not shown). The connecting portion 13a may be formed by bending a part of the cathode lead terminal 13. With the connection portion 13a as above, the resistance value between the cathode section 11b and the cathode lead terminal 13 of each capacitor element 11 can be reduced. As a result, it becomes possible to suppress the ESR of the solid electrolytic capacitor 10.

The packaging resin 17 covers the plurality of the capacitor elements 11, with each of the anode lead terminal 12 and the cathode lead terminal 13 partially exposed outside. The packaging resin 17 is constituted of an insulating resin material. The exposed portions of the anode lead terminal 12 and the cathode lead terminal 13 constitute external terminals of the solid electrolytic capacitor 10.

In the cut surface 16 of each of the anode lead terminal 12 and the cathode lead terminal 13, a first distance L1 from the first principal surface 14 to a boundary between the shear surface 16b and the fracture surface 16c is 0% or more and 80% or less of a second distance L2 from the first principal surface 14 to the second principal surface 15 (in other words, the thickness of each lead terminal 12, 13), and is preferably 0% or more and 70% or less, and more preferably 40% or more and 60% or less. When the first distance L1 falls within such a range, the burr (not shown) formed continuously to the fracture surface 16c becomes very small (e.g., 0.5 μm or less). Therefore, the occurrence of a short circuit phenomenon in the solid electrolytic capacitor 10 can be suppressed. Note that in the present embodiment, the first distance L1 is approximately 60% of the second distance L2.

### Embodiment 2

Embodiment 2 of the present disclosure will be described. A solid electrolytic capacitor 10 of the present embodiment differs from the above Embodiment 1 in that it has a single-sided structure (a structure in which capacitor elements are stacked on one side of each lead terminal). In the following, differences from the above Embodiment 1 will be mainly described.

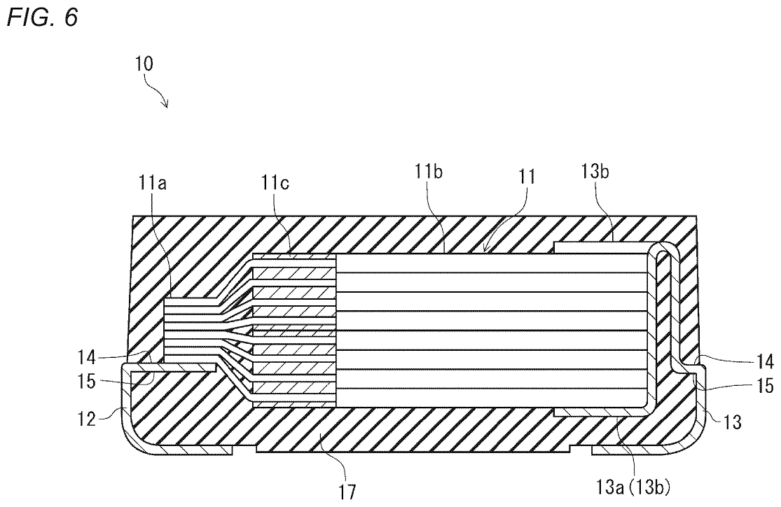

As shown in FIG. 6, the plurality of the capacitor elements 11 are electrically connected to the anode lead terminal 12 only on the first principal surface 14. The plurality of the capacitor elements 11 are electrically connected to the cathode lead terminal 13 only on the first principal surface 14.

The cathode lead terminal 13 has a guide portion 13b that guides the plurality of the capacitor elements 11. The cathode lead terminal 13 of the present embodiment has two guide portions 13b. One of the guide portions 13b is formed into a plate shape that guides a stacked body of the plurality of the capacitor elements 11 on the upper surface (the upper surface in FIG. 6). The other one of the guide portions 13b is formed into a plate shape that guides the stacked body on the lower surface (lower surface in FIG. 6). The other guide portion 13b also serves as a connecting portion 13a connected to the lower surface of the capacitor element 11. Each guide portion 13b is formed by bending a part of the cathode lead terminal 13. Note that the guide portion 13b may be formed in a plate shape that guides a stacked body of the plurality of the capacitor elements 11 on the side surface.

### EXAMPLES

The below-mentioned solid electrolytic capacitors 10 of Examples 1 to 6 and Comparative Examples 1 to 6 were checked for the frequency of occurrence of a short circuit phenomenon. Here, the frequency of occurrence of a short circuit phenomenon refers to the number of the solid electrolytic capacitors 10 in which a short circuit phenomenon occurred, per 10,000 solid electrolytic capacitors 10. For example, the frequency of occurrence of 100 means that a short circuit phenomenon has occurred in 100 solid electrolytic capacitors 10 out of 10,000 solid electrolytic capacitors 10.

The term “temper” used in the description of each Example and each Comparative Example below refers to a state of the material that has been subjected to a treatment necessary for imparting specific physical or mechanical properties to wrought copper products, as specified in JIS H 0500.

In each of the following Examples and Comparative Examples, the ratio of the first distance L1 to the second distance L2 was determined by observing the cut surface 16 of each lead terminal 12, 13 of the produced solid electrolytic capacitors 10 with an optical microscope to measure the distance L1 and the second distance L2 at ten points each, followed by calculation based on the average value of each distance.

### Example 1

In the double-sided type solid electrolytic capacitor 10 of the above Embodiment 1, the anode lead terminal 12 and the cathode lead terminal 13 were each produced using MF202 (available from Mitsubishi Electric Metecs Co., Ltd.) in H temper. MF202 contains 1.7 to 2.3 mass % of tin, 0.1 to 0.4 mass % of nickel, and 0.15 mass % or less of phosphorus, and the remainder is copper. The first distance L1 was approximately 65% of the second distance L2. The frequency of occurrence of a short circuit phenomenon was 0.

### Example 2

In the double-sided type solid electrolytic capacitor 10 of the above Embodiment 1, the anode lead terminal 12 and the cathode lead terminal 13 were each produced using NB109 (available from DOWA Metaltech Co., Ltd.) in EH temper. NB109 contains 1.0 mass % of nickel, 0.9 mass % of tin, and 0.05 mass % of phosphorus, and the remainder is copper. The first distance L1 was approximately 60% of the second distance L2. The frequency of occurrence of a short circuit phenomenon was 0.

### Example 3

In the double-sided type solid electrolytic capacitor 10 of the above Embodiment 1, the anode lead terminal 12 and the cathode lead terminal 13 were each produced using KLF-5 (available from Kobe Steel, Ltd.) in H temper. KLF-5 contains 2.0 mass % of tin, 0.1 mass % of iron, and 0.03 mass % of phosphorus, and the remainder is copper. The first distance L1 was approximately 50% of the second distance L2. The frequency occurrence of a short circuit phenomenon was 0.

### Example 4

In the single-sided type solid electrolytic capacitor 10 of the above Embodiment 2, the anode lead terminal 12 and the cathode lead terminal 13 were each produced using MF202 (manufactured by Mitsubishi Electric Metex Co., Ltd.) in H temper. The first distance L1 was approximately 65% of the second distance L2. Each of the lead terminals 12 and 13 was oriented such that the principal surface on which a burr was formed, that is, the second principal surface 15, was faced to the capacitor elements 11. The frequency of occurrence of a short circuit phenomenon was 0.

### Example 5

In the single-sided type solid electrolytic capacitor 10 of the above Embodiment 2, the anode lead terminal 12 and the cathode lead terminal 13 were each produced using NB109 (available from DOWA Metaltech Co., Ltd.) in EH temper. The first distance L1 was approximately 60% of the second distance L2. Each of the lead terminals 12 and 13 was oriented such that the principal surface on which a burr was formed, that is, the second principal surface 15, was faced to the capacitor elements 11. The frequency of occurrence of a short circuit phenomenon was 0.

### Example 6

In the single-sided type solid electrolytic capacitor 10 of the above Embodiment 2, the anode lead terminal 12 and the cathode lead terminal 13 were each produced using KLF-5 (available from Kobe Steel, Ltd.) in H temper. The first distance L1 was approximately 50% of the second distance L2. Each of the lead terminals 12 and 13 was oriented such that the principal surface on which a burr was formed, that is, the second principal surface 15, was faced to the capacitor elements 11. The frequency of occurrence of a short circuit phenomenon was 0.

### Comparative Example 1

In the double-sided type solid electrolytic capacitor 10 of the above Embodiment 1, the anode lead terminal 12 and the cathode lead terminal 13 were each produced using KFC (available from Kobe Steel, Ltd.) in H temper. KFC contains 0.1 mass % of iron and 0.03 mass % of phosphorus, and the remainder is copper. The first distance L1 was approximately 97% of the second distance L2. The frequency occurrence of a short circuit phenomenon was 71.

### Comparative Example 2

In the double-sided type solid electrolytic capacitor 10 of the above Embodiment 1, the anode lead terminal 12 and the cathode lead terminal 13 were each produced using C194 (available from Hitachi Metals Neomaterial, Ltd.) in H temper. C194 contains 2.3 mass % of iron, 0.12 mass % of zinc, and 0.05 mass % of phosphorus, and the remainder is copper. The first distance L1 was approximately 85% of the second distance L2. The frequency occurrence of a short circuit phenomenon was 3.

### Comparative Example 3

In the double-sided type solid electrolytic capacitor 10 of the above Embodiment 1, the anode lead terminal 12 and the cathode lead terminal 13 were each produced using NFC11 (available from Furukawa Electric Co., Ltd.) in H temper. NFC11 contains 0.3 mass % of chromium, 0.8 mass % of tin, and 0.2 mass % of zinc, and the remainder is copper. The first distance L1 was approximately 98% of the second distance L2. The frequency occurrence of a short circuit phenomenon was 30.

### Comparative Example 4

In the single-sided type solid electrolytic capacitor 10 of the above Embodiment 2, the anode lead terminal 12 and the cathode lead terminal 13 were each produced using KFC (available from Kobe Steel, Ltd.) in H temper. The first distance L1 was approximately 97% of the second distance L2. Each of the lead terminals 12 and 13 was oriented such that the principal surface on which a burr was formed, that is, the second principal surface 15, was faced to the capacitor elements 11. The frequency of occurrence of a short circuit phenomenon was 40.

### Comparative Example 5

In the single-sided type solid electrolytic capacitor 10 of the above Embodiment 2, the anode lead terminal 12 and the cathode lead terminal 13 were each produced using C194 (available from Hitachi Metals Neomaterial, Ltd.) in H temper. The first distance L1 was approximately 85% of the second distance L2. Each of the lead terminals 12 and 13 was oriented such that the principal surface on which a burr was formed, that is, the second principal surface 15, was faced to the capacitor elements 11. The frequency of occurrence of a short circuit phenomenon was 15.

### Comparative Example 6

In the single-sided type solid electrolytic capacitor 10 of the above Embodiment 2, the anode lead terminal 12 and the cathode lead terminal 13 were each produced using NFC11 (available from Furukawa Electric Co., Ltd.) in H temper. The first distance L1 was approximately 98% of the second distance L2. Each of the lead terminals 12 and 13 was oriented such that the principal surface on which a burr was formed, that is, the second principal surface 15, was faced to the capacitor elements 11. The frequency of occurrence of a short circuit phenomenon was 11.

As shown above, the frequency of occurrence of a short circuit phenomenon was 0 in all Examples 1 to 6, while this was not the case in Comparative Examples 1 to 6. This indicates the superiority of Examples 1 to 6.

### INDUSTRIAL APPLICABILITY

The present disclosure is applicable to a solid electrolytic capacitor.

### REFERENCE SIGNS LIST

10: solid electrolytic capacitor
11: capacitor element
11a: anode section
11b: cathode section
11c: insulation section
12: anode lead terminal
12a: connection surface
12b: through-hole
13: cathode lead terminal
13a: connecting portion
13b: guide portion
14: first principal surface
15: second principal surface
16: cut surface
16a: sag
16b: shear surface
16c: fracture surface
17: packaging resin
L1: first distance
L2: second distance

1. A solid electrolytic capacitor, comprising:
at least one capacitor element having an anode section and a cathode section;
an anode lead terminal electrically connected to the anode section; and
a cathode lead terminal electrically connected to the cathode section; wherein
each of the anode lead terminal and the cathode lead terminal has a first principal surface, a second principal surface, and a cut surface formed by cutting from the first principal surface toward the second principal surface, and
in the cut surface of at least the cathode lead terminal of the anode lead terminal and the cathode lead terminal, a first distance from the first principal surface to a boundary between a shear surface and a fracture surface is 80% or less of a second distance from the first principal surface to the second principal surface.

2. The solid electrolytic capacitor according to claim 1, wherein in the cut surface of at least the cathode lead terminal of the anode lead terminal and the cathode lead terminal, the first distance is 70% or less of the second distance.

3. The solid electrolytic capacitor according to claim 1, wherein the capacitor element is electrically connected to the cathode lead terminal only on one of the first principal surface and the second principal surface.

4. The solid electrolytic capacitor according to claim 1, comprising
a plurality of the capacitor elements, wherein
part of the plurality of the capacitor elements are electrically connected to the cathode lead terminal on one of the first principal surface and the second principal surface, and
a rest of the plurality of the capacitor elements are electrically connected to the cathode lead terminal on the other one of the first principal surface and the second principal surface.

5. The solid electrolytic capacitor according to claim 1, wherein the anode lead terminal has a through-hole in a connection surface on which the at least one capacitor element is connected.

6. The solid electrolytic capacitor according to claim 1, wherein the cathode lead terminal has a guide portion that guides the at least one capacitor element.
